(19) United States
(12) Patent Application Publication
(10) Pub. No.: US 2006/0085696 A1
(43) Pub. Date: Apr. 20, 2006

(54) Monitoring unit for monitoring and automatic clearance of faults in medical applications

(76) Inventors: Sabine Bauer, Erlangen (DE); Karol Ruckschloss, Erlangen (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/252,942

(22) Filed: Oct. 18, 2005

(30) Foreign Application Priority Data
Oct. 19, 2004 (DE) 10 2004 050 905.0

(51) Int. Cl. G06F 11/00

(52) U.S. Cl. 714/47

(57) ABSTRACT

Monitoring unit for monitoring and automatic clearance of faults in medical applications The invention in particular relates to a method, a device and a system for monitoring a plurality of applications, in particular of medical technology applications, in a network, with a monitoring unit and the central task of this unit is to carry out the monitoring. The monitoring unit requests a status report from the applications at regular intervals in time. If the status report includes a fault condition, a search is activated in a database in order to find a mechanism for clearing the faults. This mechanism for clearing the faults is converted into application-specific commands for fault clearance. As a result, the mechanism for clearing the faults is executed by sending the commands to the application.

### CROSS REFERENCE TO RELATED APPLICATIONS

This application claims priority to the German application No. 10 2004 050 905.0, filed October 19, 2004 which is incorporated by reference herein in its entirety.

### FIELD OF INVENTION

The invention falls within the scope of monitoring and fault clearance in processes. The processes to be monitored form part of a network.

The main area of application of said invention and as a result also of the processes lies in the field of medical technology, in particular involving radiological systems.

The invention in particular relates to a method, a device and a system for monitoring a plurality of applications, in particular of medical technology applications, in a network, with a monitoring unit, the central task of this unit being to carry out the monitoring.

### BACKGROUND OF INVENTION

The architecture of such a network is usually embodied in such a way that a plurality of applications or-users communicate with one another via the network. In particular, in the field of medical technology, the high availability and an optimum reliability of the system is an essential requirement for the application thereof. The monitoring of such systems thus takes on a greater significance.

In the case of known monitoring systems from the prior art, each individual process had to be monitored separately and at the level of the process. The architecture of known systems is based on the concept of only providing the processes at one level and not introducing any overlapping entities, i.e. hierarchically higher-ranking entities. This has the disadvantage that cross-process monitoring is not possible.

### SUMMARY OF INVENTION

Until now, so-called “watchdogs” or process monitors were used, which check whether or not the specific process runs trouble -free. If a fault condition is recorded, either the process can be restarted or the service technician can be called in order to manually clear the fault condition again. Over and above this, provision is made that a so -called log file is maintained in which all the recorded faults of different processes are stored in the form of tables. The log file is used to reconstruct specific fault scenarios and can make the work of a service technician easier, if required.

However, the known procedure in accordance with the prior art also entails a few disadvantages.

Seen from a cost point of view, it has proved to be disadvantageous that, in principle, a service technician has to be called for manual clearance of faults.

In addition, it has proved to be inefficient for the diagnosis or fault search to only be carried out separately for each individual process component, i.e. cross-process fault conditions cannot be identified.

The fact that fault-specific information is only stored in the log file has until now meant that it was not possible to answer specific requests on the part of a component or on the part of a server. Until now, the technician had to run specific filter s manually on the log file in order to be able to delimit the relevant aspects of a problem.

As shown in FIG. 5 for the prior art, all the aspects of the individual modalities or applications were indeed recorded in the central log file; however, an cross-application fault scenario could not be identified with this approach. Should, for example, a PACS application (Picture Archiving Communication System) communicate with an RIS application (Radiology Information System) and if the watchdog used, records that no image is displayed on the workstation, there may be a plurality of causes for this in each case. The diagnostic possibilities of previous watchdog systems are very limited. In this case, it was possible to make a diagnosis when the fault was caused by the specific application itself. A PACS system for example thus identifies inconsistent patient data. However, the watchdog for the PACS system cannot decide whether or not the fault of the inconsistent patient data has been caused by its process-specific fault configuration or by another cause, for example, by the RIS system.

In addition, the fault clearance options of previous systems are very limited. Essentially, only two concepts for fault clearance are available: On the one hand, a restart of the system can be initiated and, on the other hand, a service technician can be informed.

Therefore it is an object of this invention to demonstrate a way by means of which cross-process or cross-application fault conditions can be diagnosed automatically and which also makes possible an automatic fault correction and which, in addition, makes it possible -for a fault to be corrected in advance, i.e. before the fault has been identified by the personnel or the user.

This object of the invention is achieved by the claims.

The object of the invention is achieved in particular by methods for monitoring and/or for fault clearance of a plurality of predominantly medical technology applications, in particular, radiological applications, which communicate with one another via a network and which accesses a monitoring unit, in which case all the applications communicate via a uniform monitoring interface and in which case monitoring takes place by the monitoring unit requesting a status report from the application to be monitored in each case and if the status report includes a fault condition, initiating the following steps:

Searching in a database for a mechanism for fault clearance allocated to the recorded fault condition with allocated application-specific commands for fault clearance and the carrying out of the mechanism for fault clearance by transmitting commands from the monitoring unit via the monitoring interface to the application.

The main area of application of this invention falls within the scope of radiological applications. However, it is alternatively likewise possible to transfer the said system for monitoring and fault clearance to any other technical areas in which a plurality of applications is to be monitored via a network for freedom from faults such as, for example, control plants in energy engineering, industrial processing engineering plants, manufacturing plants, in particular, in the automotive industry, etc.

In an initial phase, there is provision in accordance with the invention that all the applications be developed with a uniform monitoring interface via which the applications are connected with one another and with other units via the network. In an additional, likewise preceding phase in time, which can nevertheless be independent of the first phase and the actual monitoring process, the individual modules or applications to be monitored send a file with process data preferably in the form of a table via their monitoring interface. This process data includes application-specific data and/or data which, in principle, can be sent from the specific monitoring interface to the monitoring unit as well as commands, which in principle can be executed on the application and are used for fault clearance and can be initiated by the monitoring unit via the monitoring interface.

However, in this/these initial phase(s) each system to be monitored sends its basic monitoring data to the monitoring unit. As a result, during later monitoring, the monitoring unit therefore knows which process data it can expect from the specific application. Advantageously, provision is made for providing this process data once during maintenance of the overall system. However, as an alternative it is also possible to send the application-specific process data for each booting of the specific application and/or the monitoring system.

In the preferred embodiment, all the applications to be monitored send this process data. This has the advantage that the monitoring unit, in principle, has stored all the process data of all the applications even when, for example, an application is only to be included in the monitoring process at a later point in time. In alternative embodiments, the user or the system administrator has additional control and influencing possibilities, in which provision is made for the fact that only a few selected, relevant applications send the process data to the monitoring unit. This has the advantage that process data need not be sent unnecessarily to the monitoring unit if, for example, the specific application is not to be monitored at this point in time.

After the relevant initial phases have been concluded, the actual monitoring phase can be started. To this end the monito ring unit requests a status report from the application to be monitored in each case.

In a preferred embodiment, provision is made for the monitoring unit, in principle, to request the status report from all applications in order to be able to obtain a monitoring result. In an alternative embodiment, the extent of the monitoring action of the method in accordance with the invention is limited. The status report is then only requested from selected and/or relevant applications. This has the advantage that the monitoring unit only has to process relevant data at this point in time.

Depending on the subsequent analysis of the status report in accordance with the invention, two process sequences are available, in principle:
1. If the status report does reveal any fault condition, no additional measures for fault clearance are introduced and the monitoring can be continued directly afterwards with or at a later point in time.
2. If the analysis of the status report shows that there is a fault condition, a searc h in the database will be initiated. A search is carried out, in particular, in order to determine whether or not at least one mechanism for fault clearance has been allocated to one of the recorded fault conditions. If such a mechanism for fault clearance can be found, application-specific commands for fault clearance are computed. This usually concerns a command sequence, i.e. a plurality of commands. However, in the case of simple faults only one command may be sufficient to clear the fault in each case.
   The mechanism for fault clearance is then carried out by the calculated commands being sent from the monitoring unit via the monitoring interface to the application. In this case, the method in accordance with the invention therefore includes an automatic fault recovery.

It has proved to be particularly advantageous in practice that in addition to the level of applications in accordance with the invention, a hierarchically higher-ranking level has been provided in which the monitoring unit acts as a cross -application central entity. This means that the applications in each case communicate via the monitoring interfaces with the monitoring unit via the network and the monitoring unit can operate both across processes and/or across applications. This procedu re also has the advantage that the diagnostic possibilities and the allocated mechanism for fault clearance can be markedly increased. It is also possible to identify faults which are not connected with the application, but which for example are in the basic network or in other components and can therefore have other causes. If an RIS application for example sends image data to a PACS application for archiving and if the PACS application does not receive the image data, then it is nevertheless possible in accordance with the invention to identify the fault, if it lies, for example, in a corrupt data transmission channel. In previous systems, this was not possible.

In principle, the monitoring unit requests the status report in accordance with predetermined time intervals, in particular, at regular intervals. This has the advantage that the user need not effect any additional settings and that the status report is requested in a fully automatic method. However, it is also possible to carry out additional control possibilities while the status report is requested after the expiry of time intervals, which can be set, and/or after the occurrence of specific, semantic context conditions. Here, it is for example possible for rules which specify in which situations a status report should be requested to be stored in a knowledge base. In the case of high network utilizations, a setting can be made to monitor all the applications which require an exchange of high data volumes. By means of these control possibilities in accordance with the invention, the method can be adapted dynamically to different monitoring scenarios.

Advantageously, provision has been made for the mechanism for fault clearance to be carried out fully automatically in accordance with the invention. This is possible because in the database at least one mechanism for fault clearance is allocated to a plurality of fault conditions in each case. Because the system is preferably a self-learning system in that the database is expanded continuously by the current monitoring cases so that an increasing number of fault conditions can be allocated to the strategies for fault clearance, the system in accordance with the invention can be carried out fully automatically for a plurality of cases. However, in the other cases, and/or if required by the user, fault clearance can also be carried out semi -automatically.

Advantageously, the method in accordance with the invention is embodied in two phases. In an initial phase, the specific application sends application-specific process data to the monitoring unit via the monitoring interface. Here, the key variables of the status report and, in principle, additional feasible, application-specific commands and/or commands for fault clearance are logged. Based on the trans mission of the process data, the monitoring unit in the subsequent phase, i.e. the actual monitoring phase, knows which data to expect in the status report from the application. As a result, it is advantageously possible to monitor the sending of the status report on the part of the monitoring unit for freedom from faults. If the application, for example, in the case of the monitoring process only sends a part of the status report, then the monitoring unit knows that it must be a fault in this case because the extent of the status report has already been determined in the initial phase.

Preferably, the interface between the applications and the monitoring unit is standardized. This means that the applications with the monitoring unit only communicate via the monitoring interface. This interface is preferably based on an open standard, such as for example SOAP-XML, HTTP-based or TCP/IP. This allows additional applications and/or other process modules to communicate with the monitoring unit and/or with the applications and that, in particular, the data of the monitoring processes can be used for additional purposes.

In an advantageous further development, the invention is embodied in such a way that the database includes cross-system and/or cross-application fault conditions. This means that not only application-specific faults are stored in the database, but also other possible faults and causes. Thus the extent of the diagnosis and fault clearance in accordance with the invention can be markedly increased because for example faults in a transmission process can also be identified.

The search in the database preferably takes place automatically. As a result of this, the efficiency of the method can be increased, on the one hand, and possible faulty operations can be reduced on the other hand. The database is maintained constantly and continuously and enriched with new allocations. By increasing the degree of automation, personnel costs can be reduced in an advantageous manner and the freedom from faults of the monitoring system can be increased.

With the method proposed here, it is possible to identify recurring problems unambiguously and to provide a solution to the problem in an automatic manner.

The uniform interface makes the system very adaptable and additional applications can be added to the monitoring system without any problems. Therefore, the expandability and the reusability can also be markedly increased.

Medical technology system in clinical everyday life usually demand high availability. Therefore, the solution in accordance with the invention is preferably embodied as a high-availability system. The monitoring unit is preferably embodied in such a way that it can communicate with high -availability systems and can react to very quickly modified system configurations in this manner.

In an advantageous further development, the invention is embodied in such a way that it includes the previous procedure in accordance with the prior art and includes an active notification of other service systems and/or the service personnel via different media (e.g. SMS, telephone and/or e-mail or the like).

In addition, the monitoring unit is connected to the applications in such a way that a failure of the monitoring unit does not influence the operability of the applications to be monitored, in particular, of the radiology systems. The individual process units can, as is known, carry out a separate monitoring and/or fault analysis.

An important advantage of the solution in accordance with the invention is that the availability of the overall system, in particular the radiology system, can be markedly increased by automating and preferably running completeness checks on the collection or recording of the relevant status information.

In principle, the method in accordance with the invention is embodied in such a way that in the case of a recorded fault condition of the status report, a database request is made. This database request determines whether or not a mechanism for fault clearance has been allocated to the recorded fault condition. If such a mechanism for fault clearance can be found, a check is then carried out as to whether or not application -specific commands for fault clearance can already be determined in the database. If this is the case, these commands are sent to the specific application via the monitoring unit.

However, if this is not the case, and the database therefore only has one general mechanism for fault clearance, the invention is characterized by an additional step of the process, namely to the effect that the recorded mechanism for fault clearance is automatically converted into a command (or into a command sequence) for fault clearance with regard to the application. In the case of this transformation of the general mechanism for fault clearance into actual, application-specific commands provision is made in accordance with the invention for, if required, the further process data required in addition to be determined by the application. If the conversion process step no longer requires any additional process data, it will be effected immediately.

In the case of said embodiment of the invention which has just been described, the device is characterized by an additional component, in particular, by a conversion module, which is intended for converting the recorded mechanism for fault clearance into application-specific commands for fault clearance.

The said embodiments of the method in accordance with the invention can also be embodied as a computer program product, with a medium which can be read by a computer and with a computer program and associated program code means, in which case the computer after loading the computer program is induced to carry out the above-described method in accordance with the invention.

An alternative solution provides for a storage medium which is intended for storing the computer-implemented method previously described and which can be read by a computer.

Additional, advantageous embodiments are defined in the dependent claims.

### BRIEF DESCRIPTION OF THE DRAWINGS

The following detailed description of the drawings describes the embodiments to be understood in a non-limiting way with their features and additional advantages based on the drawing. They are as follows:

FIG. 1 an overview-type representation of important components in accordance with a preferred embodiment of this invention;

FIG. 2 three different application systems which interact with a monitoring unit;

FIG. 3 an exemplary representation of an information flow in the case of a fault recorded by the system in accordance with the invention and with regard to one of the applications,

FIG. 4 a flowchart in accordance with a preferred embodiment of the invention and

FIG. 5 an overview-type representation of important modules of a known monitoring system from the prior art.

### DETAILED DESCRIPTION OF INVENTION

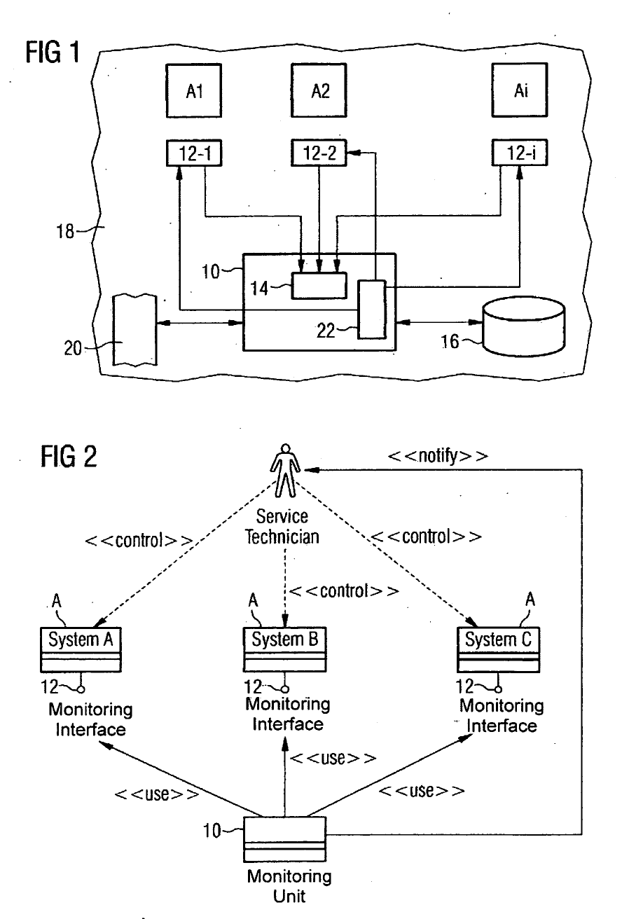

FIG. 1 gives an overview of the basic structure of the arrangement in accordance with the invention. A plurality of applications in general designated with A (on the drawing A1, A2 . . . Ai) communicate via a network 18. Preferably, the kind and type of network 18 is unremarkable for the solution in accordance with the invention and this means that this solution can basically be applied to all network cards. Preferably, applications A are hardware-based and/or software-based systems which fall within the scope of radiology. Each application A has a monitoring interface 12 (on the drawing monitoring interfaces 12-1, 12-2 . . . 12-i). Therefore, it is important in this case, that it is a uniform interface so that each radiological system to be monitored can be addressed and/or communicate via the same monitoring interface 12. The central element of the device in accordance with the invention is the monitoring unit 10 which is embodied for monitoring and/or for clearing faults with regard to the applications A. The monitoring unit 10 includes a recording module 14 and a module for fault clearance 22. The monitoring unit 10 exchanges data with a database 16.

The recording module 14 is intended for requesting relevant process data from the applications A to be monitored in each case and for sending this data to the monitoring unit 10. In the preferred embodiment, the process data is application -specific key variables for a so-called status report. This status report should be the basic principle for the monitoring and/or for fault clearance. In addition, the process data includes a list of commands, which can be carried out in the specific application A and can, in principle, be used for fault clearance. The recording module 14 therefore serves to define the extent of the status report with regard to the specific application A. This preferably takes place in an initial phase, i.e. before actual monitoring.

In a main phase of the method, i.e. during actual monitoring, the monitoring unit 10 requests important parameters of the applications A to be monitored, in particular, the contents of the status report.

In an advantageous further development, the status report is not requested by the monitoring unit 10, but the recording module 14 allocated to the monitoring unit 10. However, it is also possible for an additional component to request and record the status report.

In a subsequent step of the process, the status report of the specific application A is analyzed. If the analysis concludes that a fault condition exists, database 16 will be accessed. Based on said data (type and key variables of application A, status report, point in time of the request, network loading, etc.) a request is automatically generated for database 16. A search for entries which have stored mechanisms for fault clearance allocated to the specific fault condition is then carried out in each case. If at least one such mechanism for fault clearance can be found, this is automatically based on the recorded application-specific key variables be converted into at least one command for fault clearance. This application-specific command for fault clearance is sent automatically from the module for fault clearance 22 via the interface 12 to the application A.

In this case, it can be either a singular command or a command sequence which consists of a plurality of commands. Therefore, this command is specifically tailored for the specific fault condition of application A and for possible commands of this application A for fault clearance. If a fault X, for example, exists on an application A1, the command k will be determined and subsequently sent to the application Al. If the same fault exists in the application A2, it will usually not be the same command k that is capable of resolving the fault in the application A2, but it is a command k′ intended for resolving the same fault condition X in the application A2.

In the preferred embodiment, the module for fault clearance 22 sends the command to the application A. However, in alternative embodiments it is possible for another component or the monitoring unit 10 to directly send this command via the interface 12 to the application A. In additional embodiments provision is made not only to provide a module for fault clearance 22 and a recording module 14, but a plurality of modules in order to be able to distribute the computing load in a better way. However, if the status report does not reveal any fault condition, the database 16 will not be accessed and the monitoring method is continued without any further action in a preferred embodiment. However, it is also possible that when monitoring does not detect any faults, a corresponding report and/or a corresponding flag is set which indicates that the specific application A is operating fault-free.

FIG. 2 once again shows the basic structure of the device in accordance with the invention, in particular, that the applications A communicates in each case via a uniform monitoring interface 12 with the monitoring unit 10. The monitoring unit 10 thus on the one hand serves to automatically monitor the applications A and, on the other hand, automatically clear the faults in the applications A, if a fault condition has been recorded. In addition it is possible for the monitoring unit 10 to send a notification signal to additional systems and/or to a service technician (this is indicated in FIG. 2 by the term “Notify”).

The monitoring unit 10 sends such a notification signal especially if, in the case of a recorded fault condition, a corresponding entry which refers to a mechanism for fault clearance cannot be found in the database 16. In cases in which it is a new type of fault which has not yet been recorded, the service technician may also be notified.

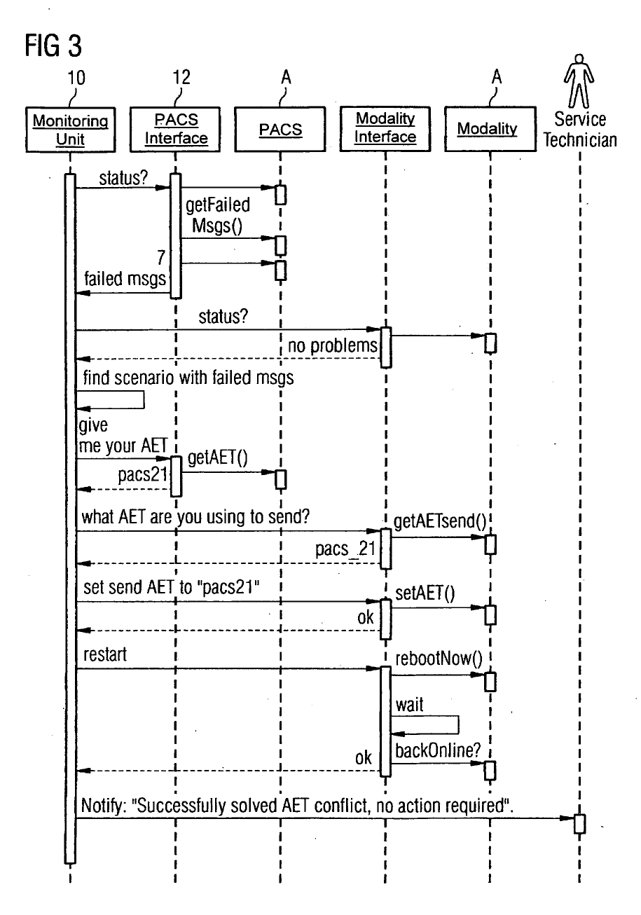

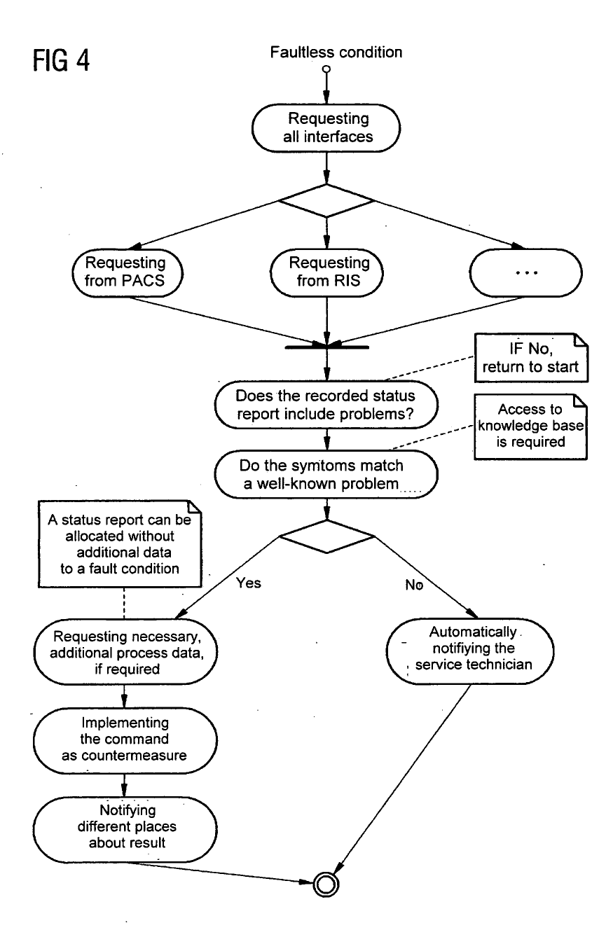

In conjunction with FIG. 3 an example is used to demonstrate how the method in accordance with the invention automatically monitors and clears faults across systems in an application A. The five upper boxes of FIG. 3 designate the modules acting in conjunction with one another: The monitoring unit 10, a first application A, in particular a PACS (Picture Archiving Communication System) which has a specific PACS interface 12 and an additional modality A which likewise has a specific interface 12. The monitoring unit 10, within the framework of its monitoring of the PACS system A, executes a request and as a result receives a status report, which refers to the fact that seven image transmissions had failed. Subsequently, the monitoring unit 10 sends a request to the additional modalities A which sent the images. The monitoring unit 10 receives the status report from modality A that the sending of the images has successfully been concluded. With this process information which, on the one hand, is the PACS application A and, on the other hand, the additional modality A, a search in the semantic database is implemented. As a result, an entry is found which refers to the fact that with such a fault condition it could in principle be that there is no conformity or a mismatch between the relevant transmission data, in particular a mismatch between so -called AETs (Application Entities based on the DICOM standard; thus the transmission data and the reception data in a specific format, in particular, the addresses of the applications A communicating in each case). As a result, a command sequence which includes a request to the PACS system is generated. This request is subsequently executed, namely the request of the monitoring unit 10 to the PACS system A, the sending address of which it had expected. As a result of this request, the monitoring unit 1 0 receives an expected sending address. This expected sending address is compared with the actual sending address, which was sent from the additional modality A. After the implementation of these steps of the process, the monitoring unit 10 provides the intermediate result that the modality A on sending the images has used the incorrect address data. The monitoring unit 10 corrects this data in the modality A and restarts this modality A.

As a result of this, a fault condition recorded within the framework of a monitoring is corrected automatically and cleared successfully. Another system and/or a service technician can be notified together with fault clearance. This example shown in FIG. 3 clearly shows that specific faults can only be identified and/or diagnosed across systems and that an application-specific fault analysis cannot produce the desired result.

In particular in cases, in which the fault is usually not in the individual application A, but in which a plurality of applications A cause a fault, the method in accordance with the invention is used. This is predominantly the case in such applications A which require either an exchange of data or a transmission of data.

FIG. 4 is a flowchart which shows the sequence in accordance with the preferred embodiment of the invention. Starting at a faultless condition of the monitoring system, the monitoring unit 10 performs status requests. The status requests are made in each case in or via the monitoring interfaces 12 of the relevant applications A (here, a PACS application and an RIS application). The collected status reports are analyzed in the monitoring unit 10. In particular, a check is performed to determine whether or not the status report includes problems or the fault conditions. If “No”, the system returns to the start condition.

Otherwise (if problems have occurred) a check is performed to determine whether or not the recorded symptoms refer to a known problem. This check is carried out using the database 16.

If the problem was not known until now and a mechanism for fault clearance could not be found in the relevant symptoms, other systems and/or the service technician are notified.

Otherwise, (if it is a known fault condition in this case) a check is performed to determine whether or not the mechanism recorded for fault clearance can at once (without additional process data in this case) be converted into application -specific commands for fault clearance. If both the information in the status report and the entry in the database 16 are sufficient in order to derive such a command or command sequence, this command sequence is executed in the specific application A via the specific monitoring interface 12.

Otherwise (if the information of the status report is in this case not sufficient to convert the mechanism recorded for fault clearance into a command for clearing faults), additional information that is required or needed is determined. In addition, this process data required or needed is then requested via the monitoring interface 12 and forwarded to the monitoring unit 10. The monitoring unit 10 can then derive from the said data (status report, mechanism recorded for fault clearance, additional process data) at least one command as a countermeasure. This command is executed. After successful execution of the commands in the application A, a corresponding notification signal is sent to systems which can be defined beforehand and/or to the service technician. The invention is preferably embodied in such a way that the user can set in advance to which systems the monitoring unit 10 should send the relevant notification signals. In the preferred embodiment, it has been predetermined for example, that the monitoring unit 10 informs the application A which has caused the fault about successful fault clearance.

A particular advantage of the monitoring method in accordance with the invention is that a plurality of fault conditions can be cleared automatically. Many faults are caused by incorrect addressing methods, for example, if an incorrect destination address or an incorrect sending address is allocated to a data record to be transmitted. Using the cross-system solution in accordance with the invention, faults which occur because of such incorrect allocations can automatically be cleared within the framework of monitoring.

The independent correction of specific fault conditions by the monitoring unit 10 is made possible while the application-specific commands for fault clearance can be taken into account and can be executed in the application A. The monitoring unit 10 automatically gathers or records the process data required for this purpose.

In the preferred embodiment of the invention, provision is made for all the monitoring process runs to be archived in a central log file 20. This log file 20 can be used in order to reconstruct process runs corrected by the monitoring unit 10 and can also be used to complete the database 16 with additional monitoring data.

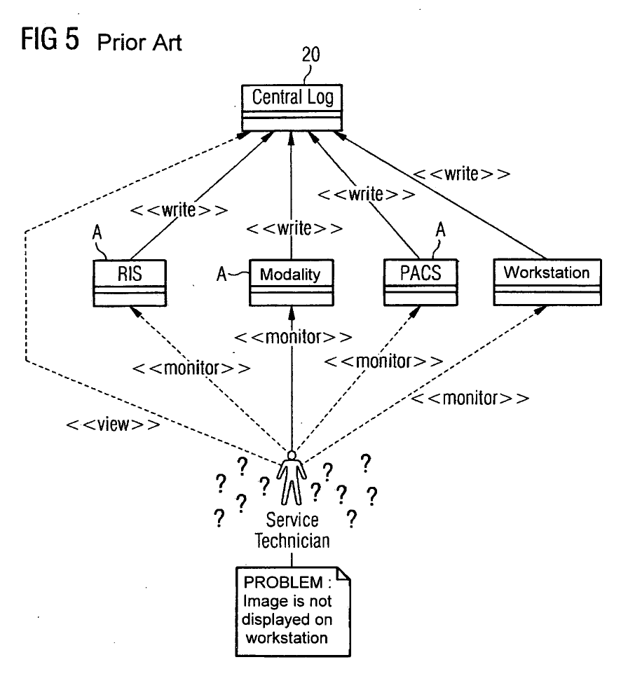

FIG. 5 explains the basic structure of known monitoring systems in accordance with the prior art. In this case, the different applications or modalities A and the additional elements and modules of the network 18 can only be monitored separately. Cross-system monitoring was not possible until now. In addition it was also not possible to perform automatic fault clearance in radiological systems which are based on the watchdog principle. It was still necessary to include a service technician.

The main area of application of said invention falls within the scope of radiological systems. However, the device, the system and the method in accordance with the invention can be used in all further fields of technology, in particular in the applications A which require an exchange of data.

The inventive combination of monitoring on the one hand and the automatic clearance of faults on the other hand makes it possible to save on computing time and to be able to guarantee an improved availability and fault tolerance of the applications a.

1.-21. (canceled)

22. A method of monitoring a plurality of applications in a network using a monitoring unit, the method comprising:
providing a uniform monitoring interface for all applications;
providing a database having a plurality of stored mechanisms for fault clearance;
establishing communication between at least two of the applications using the uniform monitoring interface; and
requesting a status report from such applications engaged in the communication by the uniform monitoring interface, wherein, if the status report includes a fault condition related to at least one application engaged in the communication, the monitoring un it:
searches the database for such stored mechanism corresponding to the fault condition, the searched mechanism including application-specific commands for clearing the fault condition, and
transmits the searched mechanism to the application having the fault condition.

23. The method in accordance with claim 22, wherein the applications are medical technology applications.

24. The method in accordance with claim 22, wherein the monitoring unit is a hierarchically higher-ranking cross-application entity communicating with the applications via the network.

25. The method in accordance with claim 22, wherein the monitoring unit requests the status report only after predetermined time intervals have lapsed or upon fulfillment of predetermined requirements.

26. The method in accordance with claim 22, wherein the searched mechanism is executed fully automatically or semi -automatically by the application having the fault condition.

27. The method in accordance with claim 22, further comprising notifying the monitoring unit about application-specific process data by the applications.

28. The method in accordance with claim 27, wherein the application-specific process data include relevant variables of the status report and in formation on such application-specific commands for fault clearance executable on the applications.

29. The method in accordance with claim 22, wherein communication between the applications and the monitoring unit is exclusively established via the uniform monitoring interface.

30. The method in accordance with claim 22, wherein the database includes cross-system or cross-application fault conditions.

31. The method in accordance with claim 22, further comprising automatically converting the searched mechanism into the application-specific commands.

32. The method in accordance with claim 22, wherein the applications, the monitoring unit and the database form a high-availability system.

33. A device for monitoring a plurality of applications in a network, the applications configured to communicate via a uniform monitoring interface, the device comprising:
a monitoring unit for recording a status report of at least one of the applications;
at least one acquisition module for acquiring from the applications:
key variables for generating the status report, and
application-specific commands executable on the applications for fault clearance;
a database including:
a plurality of fault conditions related to the applications, each fault condition assigned to a mechanism for clearing the fault condition, and
application-specific commands for clearing the fault condition; and
at least one fault clearance module configured to clear a fault condition included in the status report by accessing the database and retrieving from the database at least one such application-specific command suitable for clearing the fault condition, the retrieved application-specific command sent via the monitoring interface to the application having the fault condition.

34. The device in accordance with claim 33, wherein the monitoring unit is a hierarchically higher-ranking cross-application entity communicating with the applications via the network.

35. The device in accordance with claim 33, wherein the monitoring unit requests the status report only after predetermined time intervals have lapsed or upon fulfillment of predetermined requirements.

36. The Device in accordance with claim 33, wherein the retrieved application-specific command is executed fully automatically or semi -automatically by the application having the fault condition.

37. The device in accordance with claim 33, wherein the applications send to the monitoring unit information on such application-specific commands for fault clearance executable on the applications, before the monitoring unit starts recording activities of the applications.

38. The device in accordance with claim 33, wherein communication between the applications and the monitoring unit is exclusively established via the monitoring interface.

39. The device in accordance with claim 33, wherein the database includes cross-system or cross-application fault conditions.

40. The device in accordance with claim 30, further comprising at least one conversion module for the automatically converting the mechanism for clearing the fault condition into the application-specific command suitable for clearing the fault condition.

41. A system for monitoring a plurality of applications in a network, the system comprising:
a uniform monitoring interface;
a plurality of medical technology applications configured to communicate via the uniform monitoring interface;
a monitoring unit for recording a status report of at least one of the applications;
at least one acquisition module for acquiring from the applications:
key variables for generating the status report, and
application-specific commands executable on the applications for fault clearance;
a database including:
a plurality of fault conditions related to the applications, each fault condition assigned to a mechanism for clearing the fault condition, and
application-specific commands for clearing the fault condition; and
at least one fault clearance module configured to clear a fault condition included in the status report by accessing the database and retrieving from the database at least one such application-specific command suitable for clearing the fault condition, the retrieved application-specific command sent via the monitoring interface to the application having the fault condition.
